(19) United States
(12) Patent Application Publication
(10) Pub. No.: US 2009/0126469 A1
(43) Pub. Date: May 21, 2009

(54) Method of Monitoring Fire Resistance of Hydraulic Fluids

(75) Inventors: Ross Mitchell Walker, New South Wales (AU); Mitchell Gregory Wilson, New South Wales (AU)

Correspondence Address: NIXON & VANDERHYE, PC, 901 NORTH GLEBE ROAD, 11TH FLOOR, ARLINGTON, VA, 22203, US

(73) Assignee: CASTROL LIMITED, Swindon (GB)

(21) Appl. No.: 11/990,996

(22) PCT Filed: Aug. 22, 2006
(86) PCT No.: PCT/GB2006/003136

§ 371 Date: Feb. 26, 2008

(30) Foreign Application Priority Data
Sep. 9, 2005 (AU) 2005905000

(51) Int. Cl. G01N 9/00; C08L 33/12

(52) U.S. Cl. 73/64.54; 524/560

(57) ABSTRACT

A method of monitoring the fire resistance of hydraulic fluids involves measuring a property of the hydraulic fluid that changes as the hydraulic fluid is used; relating the measurement to the fire resistance of the hydraulic fluid; and if necessary, taking remedial action in order to improve the fire resistance of the hydraulic fluid. A suitable property is the molecular weight of polymer anti-mist additives such as polymethyl methacrylate and the fire resistance may be improved by adding to the hydraulic fluid, a concentrate of the polymer in a suitable solvent when the measured molecular weight falls below an acceptable value.

The present invention relates to a method of assessing the fire resistance of a hydraulic fluid. The present invention also provides a method of monitoring the fire resistance of a hydraulic fluid so that remedial action may be taken if the fire resistance of the fluid falls below a predetermined level.

Hydraulic fluids are specially formulated fluids that are designed to work in high pressure hydraulic systems (for example, up to 345 bar (5,000 psi)) for the purposes of power transmission and control. The fluid is designed to combine an array of properties including corrosion protection, wear resistance and reduced tendency to form varnish or sludge in valves, pipes and reservoirs present in the hydraulic system.

It is also usually very important that the hydraulic fluid exhibits a particular level of fire resistance. This is especially so for hydraulic fluids that are used in hydraulic systems where there is a high risk of fire, such as hydraulic systems used in the iron and steel manufacturing and processing industries (e.g. hydraulic systems used in blast furnaces, hot strip mills, coil handling facilities, and the like). In such systems, problems can arise when there is a high pressure fluid leak since this can give rise to a pinhole fire. It is therefore vital that the hydraulic fluid being used exhibits suitable fire resistance. Desirably, fire resistant hydraulic fluids have reduced tendency to catch fire and, in the event that they do catch fire, they do not support continuous burning after the ignition source has been removed.

There are various industry standards that specify how the fire resistance of a hydraulic fluid is to be determined and what levels are regarded as being acceptable. One such standard is the so-called 7^{th} Luxembourg protocol (Requirements and tests applicable to fire-resistant hydraulic fluids used for power transmission (hydrostatic and hydrokinetic)). One element of this protocol is a spray ignition test in which the fluid to be tested is atomised under pressure (to simulate a pinhole leak in a hydraulic system) and an igniting flame of fixed characteristics is introduced. On ignition of the fluid the flame is withdrawn. The maximum persistence of burning of the flame in the spray after withdrawal of the igniting flame is determined. For a “pass” in this test, the maximum persistence of burning should not exceed 30 seconds.

The fire resistance of hydraulic fluids tends to deteriorate over time as the fluid is used, and the rate of this deterioration tends to be associated with the extent to which the fluid is sheared during use (by pumps etc. in the hydraulic system).

U.S. Pat. No. 5,141,663 relates to the use of high molecular weight polymer anti-mist additives in order to provide a degree of fire resistance to polyalkylene glycol-based hydraulic fluids and recognises that anti-mist additives tend to degrade when subjected to shearing forces typically encountered by hydraulic fluids during use. U.S. Pat. No. 5,141,663 describes analysing the fluids by GPC in order to determine the loss in molecular weight of the anti-mist additive compared to the additive used in the comparison fluid.

Hodges P. K. B in “Hydraulic Fluids” (published by Arnold, 1996) chapter 20 relates to fire resistant fluids and maintenance of fire resistant fluids. It states that “Once a correct combination of system design and hydraulic fluid is established, the key to economic and effective operation is strict adherence to manufacturers' recommendations, systematic inspection of filters, and periodical monitoring of the hydraulic fluid by laboratory examination as indicated . . . in Table 20.2”. Such monitoring programmes include water content, pH, viscosity, micro organisms and particle count.

As the fire resistance of hydraulic fluids tends to deteriorate over time, unless some remedial action is taken, at some point the fire resistance of the fluid will fall below an acceptable level. It is not practical or economic to perform the relevant fire resistance test on site in order to determine directly the fire resistance of the fluid being used. In fact, for certain tests such as the 7^{th} Luxembourg protocol referred to, there may only be a few facilities in the world that are equipped and authorised to perform the test. It is impractical to send samples of the hydraulic fluid to such facilities for testing since the turnaround time will be unacceptably slow. Here it should be noted that large scale hydraulic systems used in industry tend to run continuously. By the time the test result is received back from a testing facility it is quite likely that the fluid will have had for some time a fire resistance below the acceptable level.

Against this background it would be desirable to provide a method of assessing the fire resistance of a hydraulic fluid that does not involve the application of the kind of fire resistance test conventionally employed. It would also be desirable to provide a method of assessing the fire resistance of a hydraulic fluid that is suitably convenient to be carried out at the location of a hydraulic system, or local thereto, and that yields results quickly thereby allowing any shortfall in fire resistance to be pre-empted or remedied rapidly. It would also be desirable to provide a method of assessing the fire resistance of a hydraulic fluid that is economic to perform so that regular checks of fire resistance become a practical possibility. This would have the advantage of ensuring that remedial action necessary to maintain a requisite level of fire resistance may be taken at the most relevant time.

Accordingly, in one embodiment, the present invention provides a method of assessing the fire resistance of a hydraulic fluid, which method comprises:
(i) measuring a property of the hydraulic fluid that changes as the hydraulic fluid is used and that can be related to the fire resistance of the hydraulic fluid; and
(ii) relating the measurement obtained in step (i) to the fire resistance of the hydraulic fluid.

This embodiment of the invention may be applied to assess the fire resistance of a hydraulic fluid where the fire resistance changes as the fluid is used in a hydraulic system. As noted, the fire resistance of such fluids tends to deteriorate as the fluid is sheared during use. This embodiment of the invention relies on measurement of some property of the hydraulic fluid that also changes during use (shearing) of the fluid and that can be correlated with fire resistance per se. It will be appreciated that the property in question is not fire resistance as such, but rather a property that can be used to provide an indication of fire resistance. It will also be appreciated therefore that a significant aspect of the present invention involves identifying the property to be measured and used as indicative of fire resistance.

Properties of a hydraulic fluid that vary as the fluid is used (sheared) may vary from hydraulic fluid to hydraulic fluid depending upon the constituents and chemistry of the fluid. The broadest embodiment of the invention is therefore not limited to measurement of any particular property, provided that the property relied upon can be related to the fire resistance of the fluid.

Preferably, the property to be relied upon is one that may be measured easily and conveniently, and with a quick turnaround time so that any unacceptable changes in fire resistance of a hydraulic fluid may be identified and acted upon without delay. The property to be measured may require the use of specialised equipment and procedures but, to the extent that these are more assessable and easy to apply than a fire resistance test itself, the invention will provide advantages when compared with direct determination of the fire resistance of a hydraulic fluid. Indeed, for the present invention to provide advantages over direct measurement of fire resistance, the property relied upon could simply be one that has less associated practical constraints than the fire resistance test, be that location, ease of use or cost.

For any particular measurable property to be useful in practice of the present invention, the property must be able to be related to the fire resistance, as determined by whatever test/standard is relevant. Thus, it is still necessary to perform the fire resistance test in order to characterise the fluid by reference to the property of interest. However, after this characterisation has been undertaken, the property may be relied upon as an indicator of fire resistance without needing to resort to fire resistance testing.

In order to characterise a hydraulic fluid, its fire resistance and the property of interest are measured when the fluid is fresh/new and also after various periods of shearing that are intended to simulate use of the fluid (eg. by cycling the fluid through a pump). In this way it is possible to ascertain how the fire resistance of the fluid deteriorates and how that deterioration correlates with the change in the property of interest. Advantageously, it is possible to determine the value of the property that equates to a fail in the relevant fire resistance test. By characterising the hydraulic fluid in this way, subsequent measurement of the property of interest may be used as a direct indication of when the fire resistance of the hydraulic fluid is unacceptably low so that remedial action can then be taken, if necessary.

As mentioned above, in its broadest embodiment the present invention is not limited by reference to any particular property to be measured. However, from a practical point of view, it is obviously desirable that the property to be relied upon is one that has associated advantages (such as convenience, cost etc.) when compared with the relevant fire resistance test itself. The property to be measured as representative of fire resistance may vary from fluid to fluid and, even when the same property is relied upon, the threshold value that represents the demarcation between acceptable and unacceptable fire resistance may vary as between different hydraulic fluids. The present invention relies on the pre-characterisation of a particular type of fluid to be used and the results obtained should not be taken as being representative of a fluid of different composition, or as being useful in characterising such a fluid.

The property to be relied upon may be any physical of chemical property that will change as the hydraulic fluid is used and that can be related to the fire resistance of the fluid. Useful properties may include viscosity, density, compressibility, conductivity, Prandtl number, specific heat, surface tension, vapour pressure, molecular weight (number average or weight average) and boiling point. It is preferred to use the molecular weight (most preferably, the weight average molecular weight) of polymer anti-mist additive in the fluid. One skilled in the art will be familiar with how such properties may be determined using standard equipment and techniques. It is envisaged that a sample of hydraulic fluid will be taken from a convenient part of the hydraulic system and analysed so that the property of interest can be assessed.

In another embodiment, the present invention provides a method of ensuring that a hydraulic fluid being used in a hydraulic system has sufficient fire resistance. In this embodiment the method comprises:
(i) measuring a property of the hydraulic fluid that changes as the hydraulic fluid is used and that can be related to the fire resistance of the hydraulic fluid;
(ii) relating the measurement obtained in step (i) to the fire resistance of the hydraulic fluid; and
(iii) if necessary, taking remedial action in order to improve the fire resistance of the hydraulic fluid.

In this embodiment it is envisaged that the relevant property of the hydraulic fluid will be monitored by periodic checks in order to develop an understanding of changes in the fire resistance of the fluid and, in particular, to identify when the fire resistance of the fluid is approaching an unacceptably low level. In practice, it is unlikely that the monitoring system will be set up based on a value of the measured property that corresponds to a “fail” in the relevant fire resistance test. Rather, the method will be applied to identify that point at which a “fail” is being approached. When that point is reached, remedial action can be taken in order to improve the fire resistance of the fluid.

It will be noted that steps (i) and (ii) are the same as recited above and similar principles therefore apply. In this later embodiment of the invention, the period between sampling and measurement of the relevant property may vary depending upon the characteristics of the hydraulic system and/or the hydraulic fluid being used. For example, if a hydraulic system is one that imparts high shear on a hydraulic fluid, it is possible that the fire resistance of the fluid may deteriorate more rapidly than when the same fluid is used in a low shear system. In this case, more frequent sampling of the hydraulic fluid may be required in order to determine that point at which the fire resistance of the hydraulic fluid is approaching an unacceptably low level.

In the preferred aspect, the equipment used for measurement of the property in question is incorporated as part of the hydraulic system so that on-line sampling and measurement may take place. The nature of the property to be measured, and the type of equipment required for this, will obviously dictate whether this is a practical possibility. Otherwise, it may be necessary to sample hydraulic fluid and remove it for testing. It will be preferred that testing is “on site” but, again, this will depend upon the nature of the property to be measured.

When it has been determined that the fire resistance of the hydraulic fluid being used is approaching an unacceptably low level, remedial action may be taken in order to enhance the fire resistance. It is highly desirable, if not essential, that the remedial action is taken in such a way that the method of the invention may still be employed in order to ensure that a suitable level of fire resistance is maintained. This is likely to have implications as to what steps can be taken in order to improve the fire resistance of hydraulic fluid once it has been determined that the fire resistance is approaching an unacceptably low level. This is because this aspect of the invention relies on the fact that a particular type of hydraulic fluid (composition) has been pre-characterised so that some property can be regarded as being representative, at least qualitatively, of fire resistance of the fluid. At one extreme, the remedial action might involve replacing the entire hydraulic fluid being used in a system with fresh fluid of the same original composition as was originally characterised. However, this is unlikely to be done in practice. More likely, the hydraulic fluid in the system will be dosed with a suitable concentrate or component(s) in order to boost the fire resistance. The characteristics of the concentrate or component(s) used should not, however, disrupt the ability to monitor the fire resistance of the hydraulic fluid subsequently in accordance with the present invention. For similar reasons, when the hydraulic fluid used in a system has been changed to a different type of hydraulic fluid and it is intended to monitor the fire resistance of that different hydraulic fluid in accordance with the present invention, it is important that the system is suitably flushed in order to prevent any residual/existing hydraulic fluid interfering with the fresh hydraulic fluid to be introduced.

For purposes of illustration, the present invention will now be described with reference to a particular type of commercially available fire resistant hydraulic fluid.

It is known to use as fire resistant hydraulic fluids, base fluids incorporating high molecular weight polymer anti-mist additives in order to provide the requisite level of fire resistance. Anti-mist additives are compounds that are intended to cause coalescence of droplets of the hydraulic fluid in the event that the fluid is atomised, such as when a high pressure pinhole leak occurs. In turn, coalescence of droplets of the fluid reduces the propensity of the fluid to support a flame. There are numerous types of compounds useful as anti-mist additive, and mention may be made of polyalkyl (meth)acrylates such as polymethyl methacrylate, alkylene-vinyl ester copolymers, polybutadiene styrene copolymers, and combinations thereof. It is known to employ these types of anti-mist additive in polyol ester-type base fluids.

In accordance with the invention it has been observed that, when exposed to shearing, polyalkyl(meth)acrylate anti-mist additives are degraded and that this coincides with a reduction in the fire resistance of the hydraulic fluid in which the anti-mist additive is included.

Being a polymer, the anti-mist additive will include a variety of polymer chain lengths. The anti-mist additive may therefore be characterised by reference to a particular molecular weight distribution. It is believed however that for a particular level of fire resistance to be observed, the hydraulic fluid must contain a sufficient concentration of particular fractions within this molecular weight distribution. In accordance with the present invention it is therefore possible to rate the fire resistance of a hydraulic fluid incorporating this type of anti-mist additive by determining the extent to which the relevant fractions of the anti-mist additive are present. As the hydraulic fluid is used it is believed that the concentration of relevant fractions will be diminished. Thus, the molecular weight and in particular, the weight average molecular weight, of the anti-mist additive in the hydraulic fluid may be measured and related to the fire resistance of the hydraulic fluid. This characteristic (the molecular weight of the polymer anti-mist additive) of the fluid may therefore be used as an indicator as to fire resistance. In practice, the molecular weight of the polymer anti-mist additive of the fluid may be assessed using gel permeation chromatography (GPC). This is believed to be a convenient and simple to use measurement technique.

Remedial action according to the present invention may comprise adding to the hydraulic fluid, the same type of polymer anti-mist additive as originally present in the hydraulic fluid. The polymer may be fresh or unused. The polymer should be in a suitable physical form to achieve suitable dilution in the remainder of the fluid, for example as a solution of the polymer anti-mist additive in a solvent which is compatible with the hydraulic fluid. A suitable solvent may be canola oil or rape seed oil.

In accordance with the present invention, after the hydraulic fluid has been characterised as required, GPC data may then be used to ascertain when the fire resistance of the hydraulic fluid is reaching an unacceptably low level in practice. The fire resistance of the hydraulic fluid can be improved and this is likely to comprise adding to the fluid the same type of anti-mist additive as originally present in the hydraulic fluid. This ensures that the fire resistance of the hydraulic fluid may be monitored using the same approach.

Thus, also according to the present invention there is provided a method of improving the fire resistance of a hydraulic fluid which comprises a polymer anti-mist additive, the molecular weight of which changes as the hydraulic fluid is used, which method comprises adding to the hydraulic fluid the same type of polymer anti-mist additive as originally present in the hydraulic fluid.

The polymer anti-mist additive may be added as a concentrate comprising a solvent compatible with the hydraulic fluid. A suitable solvent may be canola oil or rape seed oil.

Thus, for example it have been found that the weight average molecular weight of a polymethyl methacrylate anti-misting additive in a hydraulic fluid may fall in use, from an initial value of about 1.4 million to a value of about 200000, at which point the fluid has an unacceptable fire resistance.

The fire resistance of the hydraulic fluid may be improved by adding to the hydraulic fluid polymer anti-mist additive comprising polymethyl methacrylate. The polymer anti-mist additive may be added as a concentrate in a solvent compatible with the hydraulic fluid, for example as polymethyl methacrylate in canola oil or rape seed oil.

Also, according to the present invention there is provided a concentrate for use in the methods of the present invention which comprises polyol ester, polymethyl methacrylate, canola oil or rape seed oil and optionally, at least one additive selected from the group consisting of antioxidants; antiwear additives and antifoam additives.

The concentrate may comprise 30 to 50 weight % polyol ester, 8 to 17 weight % of polymethyl methacrylate, 25 to 43 weight % canola oil or rape seed oil and 0 to 1 weight % at least one additive selected from the group consisting of antioxidants, antiwear additives and antifoam additives.

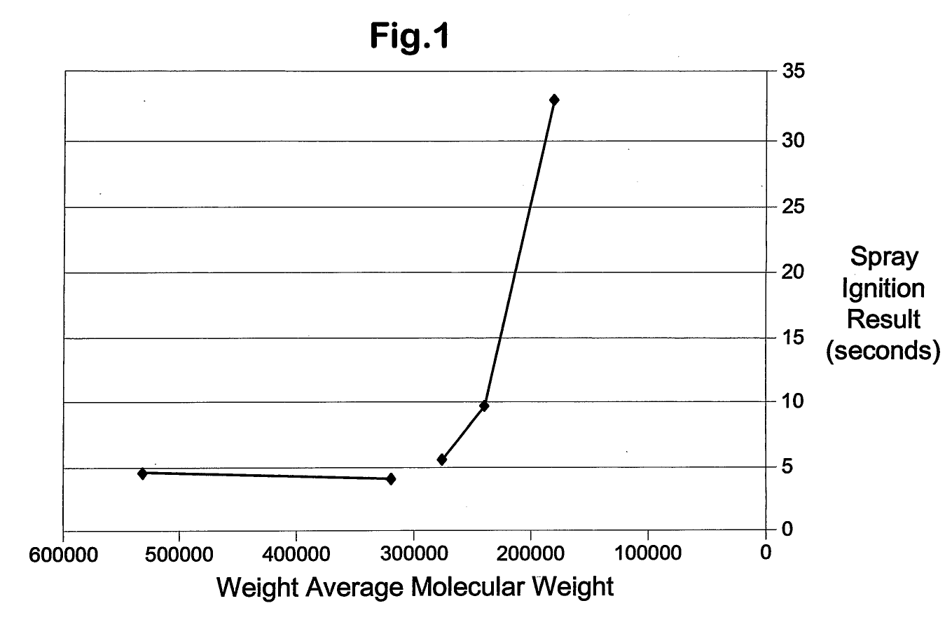

The present invention will now be illustrated with reference to the following non-limiting examples and FIG. 1 which represents in graph form, the relationship between weight average molecular weight of a polymethyl methacrylate anti-mist additive in a hydraulic fluid and the fire resistance of the hydraulic fluid as measured by a spray ignition test.

### EXAMPLE 1

The hydraulic fluid used in this example was Anvol SWX-P 68, commercially available from Castrol. This comprises a polyol-ester base fluid and includes a high molecular weight polymer as anti-mist additive. The molecular weight distribution of this additive was known or determined in advance.

The hydraulic fluid was subjected to shearing for various periods of time using a closed loop hydraulic system including a Vickers 20 DT5A vane pump equipped with a relief valve and radiator. A temperature probe was set between 48-53° C. and a radiator fan was used for cooling when required. A level switch was incorporated in the system to detect any leaks and to turn the system off should a leak be identified. During operation the hydraulic pump ran at around 800 psi and the fluid temperature was set to around 49° C. The volume of fluid circulated was approximately 70 litres at room temperature. The flow rate of fluid was approximately 23 litres per minute.

The fluid was sheared for determined periods of time by circulation through the pump and a sample was taken at predetermined intervals. The sample was tested to determine its fire resistance and to ascertain the concentration of these fractions of anti-mist additive believed to be significant for fire resistance. This was done using GPC as described below.

Gel permeation chromatography analysis involved dissolution of samples in tetrahydrofuran (about 30 mg/ml) with subsequent analysis using a Polymer Laboratories Mixed Bed A Gel Permeation Chromatography column, tetrahydrofuran being used as the mobile phase, Agilent HP 1100 and Agilent GPC being used as software. Ten samples of the anti-mist additive compound were also analysed in order to provide a calibration. During testing, samples were analysed twice in order to provide an average result.

In this way, it is possible to determine the molecular weight characteristic for the hydraulic fluid that corresponds to a fail result in the fire resistance test. This molecular weight characteristic can then be used in practice in order to determine when the fire resistance of a hydraulic fluid is reaching an unacceptably low level.

The following table shows molecular weight (number average and weight average) against duration of shearing. The molecular weights were determined from GPC using standard methodology.

Spray ignition tests (7^{th} Luxembourg protocol) were conducted at 0 hours and after 25 hours. For 0 hours a pass result was obtained (maximum persistence of burning 6 s). After 25 hours a fail result (33 seconds) was observed.

The weight average molecular weight MW is related to the fire resistance of the hydraulic fluid as measured by the average spray ignition test result in graph form in FIG. 1. This shows that the fire resistance of the hydraulic fluid fell below the acceptable spray ignition time of 30 seconds when the weight average molecular weight of the polymer anti-mist additive fell to about 190000.

| | | | Spray Ignition |
|---|---|---|---|
| Hours Sheared | Mn | MW | (seconds) |
| 0 | 250000 | 1185000 | max 6 |
| 0.25 | 220300 | 567850 | |
| 0.5 | 196000 | 547300 | |
| 0.75 | 181500 | 495450 | |
| 0.95 | 183400 | 530950 | 4.75 |
| 1 | 179000 | 319500 | 4.17 |
| 2 | 170000 | 293500 | |
| 4 | 163000 | 275500 | 5.59 |
| 8 | 152000 | 239000 | 9.67 |
| 25 | 127500 | 179000 | 33 |
| 50 | 113500 | 151000 | |
| 75 | 108500 | 140500 | |

Thus, it is possible to measure the property (molecular weight of the polymer anti-mist additive) of the hydraulic fluid that changes as the hydraulic fluid is used and relate it to the fire resistance of the hydraulic fluid. This measurement can be undertaken more easily that the conventional spray ignition test and so the fire resistance of the hydraulic fluid can be monitored in use. The measurement can be used to indicate when remedial action can be taken to improve the fire resistance of the hydraulic fluid. Such remedial action may comprise adding to the hydraulic fluid, polymer anti-mist additive of the same type as was originally in the hydraulic fluid. For example, a concentrate comprising poly-methyl methacrylate in canola oil may be added to the hydraulic fluid.

1-21. (canceled)

22. A method of assessing the fire resistance of a hydraulic fluid which comprises a polymer anti-mist additive, which method comprises:
(i) measuring a property of the hydraulic fluid that changes as the hydraulic fluid is used and that can be related to the fire resistance of the hydraulic fluid, which property is the molecular weight of the polymer anti-mist additive; and
(ii) relating the measurement obtained in step (i) to the fire resistance of the hydraulic fluid.

23. A method as claimed in claim 22 in which the property of the hydraulic fluid that changes as the hydraulic fluid is used is the weight average molecular weight of the polymer anti-mist additive.

24. A method as claimed in claim 23 in which the weight average molecular weight of the polymer anti-mist additive is measured using gel permeation chromatography.

25. A method as claimed in claim 22 in which the polymer anti-mist additive is selected from the group consisting of polyalkyl(meth)acrylates, alkylene-vinyl ester copolymers, polybutadiene styrene copolymers and combinations.

26. A method as claimed in claim 25 in which the polyalkyl(meth)acrylate is polymethyl methacrylate.

27. A method as claimed in claim 24 in which the polymer anti-mist additive is selected from the group consisting of polyalkyl(meth)acrylates, alkylene-vinyl ester copolymers, polybutadiene styrene copolymers and combinations.

28. A method as claimed in claim 27 in which the polyalkyl(meth)acrylate is polymethyl methacrylate.

29. A method as claimed in claim 22 which comprises:
(i) measuring a property of the hydraulic fluid that changes as the hydraulic fluid is used and that can be related to the fire resistance of the hydraulic fluid, which property is the molecular weight of the polymer anti-mist additive;
(ii) relating the measurement obtained in step (i) to the fire resistance of the hydraulic fluid; and
(iii) if necessary, taking remedial action in order to improve the fire resistance of the hydraulic fluid.

30. A method as claimed in claim 29 in which the property of the hydraulic fluid that changes as the hydraulic fluid is used is the weight average molecular weight of the polymer anti-mist additive.

31. A method as claimed in claim 30 in which the weight average molecular weight of the polymer anti-mist additive is measured using gel permeation chromatography.

32. A method as claimed in claim 29 in which the remedial action in order to improve the fire resistance of the hydraulic fluid comprises adding to the hydraulic fluid, the same type of polymer anti-mist additive as originally present in the hydraulic fluid.

33. A method as claimed in claim 32 in which the polymer anti-mist additive is added in a solvent which is compatible with the hydraulic fluid.

34. A method as claimed in claim 33 in which the polymer anti-mist additive is selected from the group consisting of polyalkyl(meth)acrylates, alkylene-vinyl ester copolymers, polybutadiene styrene copolymers and combinations.

35. A method as claimed in claim 34 in which the polyalkyl(meth)acrylate is polymethyl methacrylate.

36. A method as claimed in claim 30 in which the remedial action in order to improve the fire resistance of the hydraulic fluid comprises adding to the hydraulic fluid, the same type of polymer anti-mist additive as originally present in the hydraulic fluid.

37. A method of improving the fire resistance of a hydraulic fluid which comprises a polymer anti-mist additive, the molecular weight of which changes as the hydraulic fluid is used, which method comprises adding to the hydraulic fluid the same type of polymer anti-mist additive as originally present in the hydraulic fluid.

38. A method as claimed in claim 37 in which the polymer anti-mist additive is added in a solvent which is compatible with the hydraulic fluid.

39. A method as claimed in claim 38 in which the polymer anti-mist additive is selected from the group consisting of polyalkyl(meth)acrylates, alkylene-vinyl ester copolymers, polybutadiene styrene copolymers and combinations.

40. A method as claimed in claim 39 in which the polyalkyl(meth)acrylate is polymethyl methacrylate.

41. A method as claimed in claim 40 which comprises adding a concentrate comprising polymethyl methacrylate in canola oil or rape seed oil to the hydraulic fluid.

42. A method as claimed in claim 41 which comprises adding a concentrate comprising polyol ester, polymethyl methacrylate, and canola oil or rape seed oil and optionally, at least one additive selected from the group consisting of antioxidants, antiwear additives and antifoam additives.

43. A concentrate for use in the method as claimed in claim 42 which comprises polyol ester, polymethyl methacrylate, and canola oil or rape seed oil and optionally, at least one additive selected from the group consisting of antioxidants, antiwear additives and antifoam additives.

44. A concentrate as claimed in claim 43 which comprises 30 to 50 weight % polyol ester, 8 to 17 weight % of polymethyl methacrylate, 25 to 43 weight % canola oil or rape seed oil and 0 to 1 weight % at least one additive selected from the group consisting of antioxidants, antiwear additives and antifoam additives.
